(19) United States
(12) Patent Application Publication
(10) Pub. No.: US 2017/0374001 A1
(43) Pub. Date: Dec. 28, 2017

(54) PROVIDING COMMUNICATION RANKING SCHEME BASED ON RELATIONSHIP GRAPH

(71) Applicant: MICROSOFT TECHNOLOGY LICENSING, LLC, Redmond, WA (US)

(72) Inventors: Olivia Ifrim, Oslo (NO); Manolis Platakis, Oslo (NO); Vando Pereira, Oslo (NO); Rezaul Hoque, Oslo (NO)

(73) Assignee: MICROSOFT TECHNOLOGY LICENSING, LLC, Redmond, WA (US)

(21) Appl. No.: 15/194,601

(22) Filed: Jun. 28, 2016

(51) Int. Cl. H04L 12/58; H04L 12/26

(52) U.S. Cl. CPC H04L 51/22; H04L 51/26; H04L 43/045; H04L 51/12

(57) ABSTRACT

A communication ranking scheme is provided based on a relationship graph. A communication service initiates operations to provide the communication ranking scheme by identifying an attribute of a communication upon receiving the communication intended for a recipient. A relationship graph is queried to retrieve a signal and a signal value associated with the attribute. The signal value is processed with a weight value to generate a weighted signal value that is used to compute a rank value for the communication. The rank value is provided along with the communication to a client application for ordering the communication based on the rank value.

### BACKGROUND

Information collection, management, and analysis have changed work processes associated communication management. Automation and improvements in work processes have expanded scope of capabilities offered by businesses. With the development of faster and smaller electronics execution of mass processes at cloud based systems have become feasible. Indeed, analysis work at data, centers, data warehouses, data workstations have become common business features in modern work environments. Such systems execute a wide variety of applications ranging from enterprise resource management applications to complicated product tools. Many such applications process communications to attempt, to improve interactions with the communications. Email as a communication platform offers an intersect between instant communication and reliable access to documentation associated with the communication.

Vast number of communications, data volume associated with the communication, and communication modalities complicate reliable communication between individuals, groups, and organization. Indeed, fast changing dynamics of communication modalities complicate access to information stored within a communication. Complications with multiple communication sources, communication types, and complexity of information provided by volume of communications and communication modalities, may lead to mismanagement of information transmitted through communications and access by an interested party.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a communication ranking scheme based on a relationship graph. A communication service, according to embodiments, may initiate operations to provide the communication ranking scheme by identifying an attribute of a communication upon receiving the communication sent to a recipient. Next, a relationship graph may be queried to retrieve a signal and a signal value associated with the attribute. The relationship graph may describe a relationship of the recipient within the signal. The signal value may be processed with a weight value to generate a weighted signal value. Furthermore, a rank value for the communication may be computed from the weighted signal value and other weighted signal value(s). The communication may be provided along with the rank value for ordering the communication based on the rank value.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A through 1B are conceptual diagrams illustrating examples of providing a communication ranking scheme based on a relationship graph, according to embodiments;

FIG. 2 is a display diagram illustrating example components of a communication service that provides a communication ranking scheme based on a relationship graph, according to embodiments;

FIG. 3 is a display diagram illustrating components of a scheme to provide a communication ranking scheme based on a relationship graph, according to embodiments;

FIG. 4 is a display diagram illustrating an example of an interface that provides ranked communications and rank values based on a relationship graph, according to embodiments;

FIG. 5 is a simplified networked environment, where a system according to embodiments may be implemented;

FIG. 6 is a block diagram of an example computing device, which may be used to provide a communication ranking scheme based on a relationship graph, according to embodiments; and

FIG. 7 is a logic flow diagram illustrating a process for providing a communication ranking scheme based on a relationship graph, according to embodiments.

### DETAILED DESCRIPTION

As briefly described above, a communication service may provide a communication ranking scheme based on a relationship graph. In an example scenario, the communication service may identify an attribute of a communication upon receiving the communication sent to a recipient. The attribute of the communication may include an address of the recipient, an address of a sender, an address of a co-recipient, a date and time of a transmission, a subject, ardor a context of a content of the communication, among others.

Next, a relationship graph may be queried to retrieve a signal an associated signal value that are associated with the attribute. The relationship graph may represent a collection of content and activity, and the relationships between them that happen across an entire environment such as a productivity suite. From email, social conversations, and meetings, to documents in a collaboration service and collaborative data stores, the relationship graph may map the relationships among people and information, and provide information that can be used as the foundation for many experiences that are more relevant and personalized to each individual. The relationship graph may use machine learning techniques to connect people to the relevant content, conversations and people around them. Thus, the relationship graph may describe a relationship of the recipient within the signal. In some examples, the signal may describe a frequency, a duration, a date and time, a summary, and/or a result of an interaction, among others, between the recipient and an entity. The entity may include a person (such as a sender) and/or an object (such as a document), among others.

The signal may be processed with a weight value to generate a weighted signal value. The signal value may be adjusted up or down based on a stains of the attribute as measured by the signal. A rank value may be computed for the communication from the weighted signal value. Multiple weighted signal values (for multiple signals) may be added to form the rank value for the communication. The rank value may be normalized to a number within a value range (such as 0-1, 0-10, and/or 0-100, among others). The communication may be provided with the rank value (to a client application) for ordering the communication based on the rank value.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or mare of a volatile computer memory, a non-volatile memory, a hard drive, a flash drive, a floppy disk, or a compact disk, and comparable hardware media.

Throughout this specification, the term “platform” may be a combination of software and hardware components to provide a communication ranking scheme based on a relationship graph. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

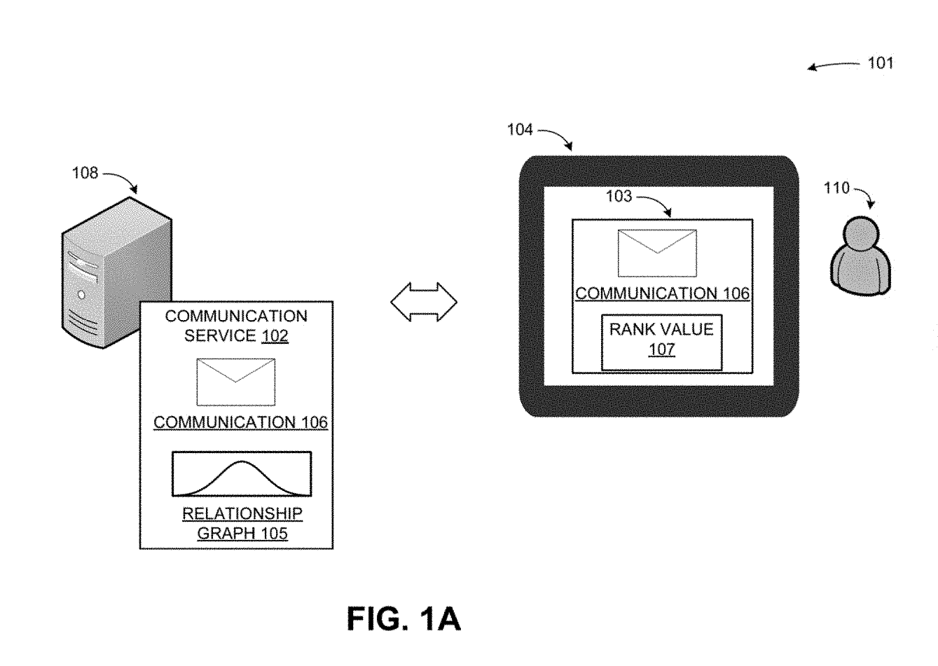

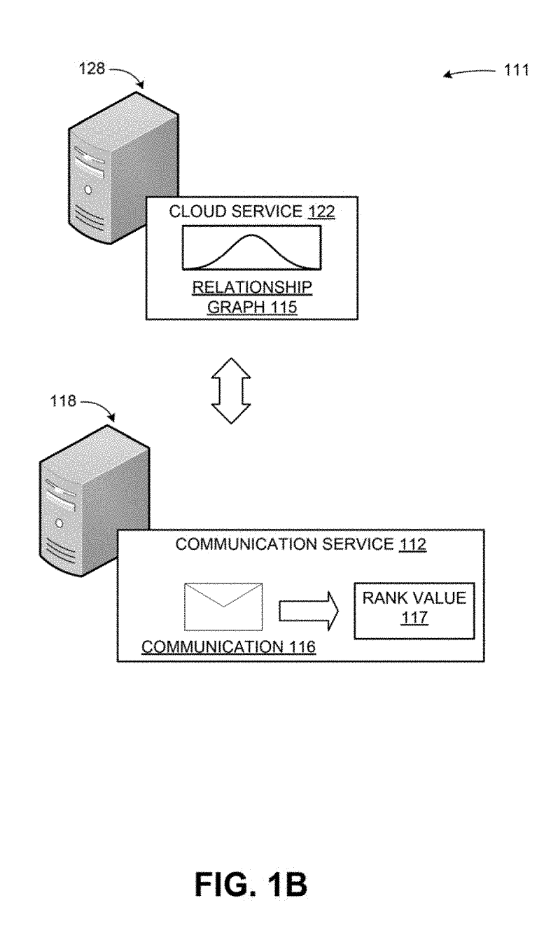

FIGS. 1A through 1B are conceptual diagrams illustrating examples of providing a communication ranking scheme based on a relationship graph, according to embodiments.

In a diagram 101, a communication server 108 may execute a communication service 102. The communication server 108 may include a physical server providing service(s) and/or application(s) to client devices. A service may include an application performing operations in relation to a client application and/or a subscriber, among others. The communication server 108 may include and/or is part of a workstation, a data warehouse, and/or a data center, among others.

The communication server 108 may execute the communication service 102. The communication service 102 may initiate operations to provide a communication ranking scheme based on a relationship graph by identifying an attribute of a communication 106, upon receiving the communication 106 (directed to a recipient 110). The attribute may include an address of the recipient, an address of a sender, an address of a co-recipient, a date and time of a transmission, a subject, and/or a context of a content of the communication, among others. In the example configuration of FIG. 1A, a relationship graph 105 may be queried to retrieve a signal and a value for the signal associated with the attribute.

The relationship graph 105 may describe a relationship of the recipient with a person and/or an object (among others) within the signal. An entity such as the recipient 110, a person, a group, an organization, and/or an object, among others may be structured as nodes within the relationship graph with each connection between the nodes describing a relationship. The relationship graph 105 may include signals that describe a frequency, a duration, a date and time, a summary, and/or a result (among others) of an interaction between the recipient 110 and an entity such as the person (for example a sender) and/or the object (for example a document attached to the communication). The relationship graph 105 may be collected, processed, generated, and/or updated by a provider such as a cloud service from a variety of sources that provide information associated with the recipient and other entities. Alternatively, the communication service 102 may manage the relationship graph 105.

Upon retrieving the signal associated with the attribute of the communication 106, the communication service 102 may process the signal value with a weight value to generate a weighted signal value. The weight value may exemplify a collection value used to describe an interest of the recipient in the communication. The weight value may be adjustable based on input by the recipient (or other stakeholder) to update the rank value of the communication 106 to match the interest of the recipient 110. The weight value may also be adjusted by a machine learning scheme that is configured to process action(s) of the recipient associated with the attribute and quantify the action(s) (or lack of) to an interest associated with the communication 106.

The signal value may be processed with the weight value to generate a weighted signal value. The weighted signal value may be aggregated with other weighted signal value(s) from other signal(s) of the communication 196 to compute a rank value 107. The communication 106 may be provided along with the rank value 107 to a client application 103 (executed on a client device 104) for ordering the communication 106 based on the rank value 107. The client device 104 may be instructed to rank the communication 106 and other communication(s) based on the rank value 107 and other rank value(s) associated with the other communication(s). The client device 104 may also be instructed to order the communication 106 based on the rank value 107 while displaying the rank value 107 along with the communication 106 to the recipient 110. The rank value 107 is provided to the recipient 110 to prompt the recipient to affirm the rank value 107 or to adjust the rank value 107 by adjusting the weight value impacting the signal associated with the communication 106.

The communication server 108 may communicate with the client device 104 through a network. The network may provide wired or wireless communications between nodes such as the client device 104, or the communication server 108, among others. Previous example(s) to provide a communication ranking scheme based on a relationship graph 105 are not provided in a limiting sense. For example, the communication 106 may include an email, a message, and/or a conference call, among others. Furthermore, the communication service 102 may alternatively manage the communication 106 at a desktop application, a workstation application, and/or a server application, among others. The client application may also include a client interface of the communication service 102,

The recipient 110 may interact with the client application 103 with a keyboard based input, a mouse based input, a voice based input, a pen based input, and a gesture based input, among others. The gesture based input may include one or more touch based actions such as a touch action, a swipe action, and a combination of each, among others.

In a diagram 111 of FIG. 1B, a system that includes a communication service 112 (executing on a communication server 118) and a cloud service 122 (executing on cloud server(s) 128) is described. The communication service 112 may interact with the cloud service 122 to process the communication 116 with a signal associated with an attribute of the communication 116. The cloud service 122 may include a third party service provider. Furthermore, the cloud service 122 may execute operations to provide the relationship graph 115. For example, the cloud service 122 may interact with content providers to download and update information associated with an entity (a node such as the recipient) and a relationship of the entity with other entity (other node).

In an example scenario, the cloud service 122 may search a social networking provider to gather information associated with a recipient, a sender, and/or a co-recipient, among others. The communication service 112 may query the cloud service 122 to retrieve a signal and a signal value associated with an attribute of the communication 116 from the relationship graph 115. A rank value 117 may be computed by applying a weight value to the signal value (and/or aggregating weighted signal values of other signal(s)). The rank value 117 and the communication 116 may be provided to a client application for a presentation of a ranked communication to the recipient.

While the example systems in FIGS. 1A through 1B have been described with specific components including the communication server 108, the communication service 102, embodiments are not limited to these components or system configurations and can be implemented with other system configuration employing fewer or additional components.

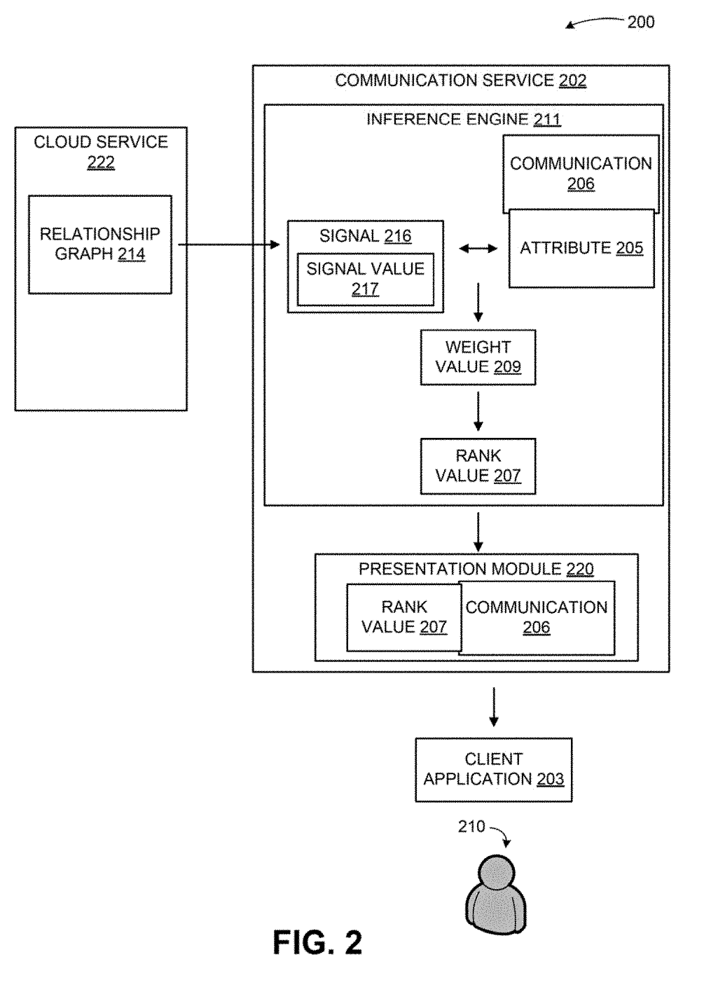

FIG. 2 is a display diagram illustrating example components of a communication service that provides a communication ranking scheme based on a relationship graph, according to embodiments.

In a diagram 200, an inference engine 211 of a communication service 202 may interact with a cloud service 222 to compute a rank value 207 based on a signal value 217 associated with an attribute 205 of a communication 206. In an example scenario, the inference engine 211 may identify an attribute 205 of the communication 206 upon receiving the communication 206 intended for a recipient 210. The attribute 205 may include an address of the recipient, an address of a sender, an address of a co-recipient, a date and time of a transmission, a subject, and/or a context of a content of the communication 206. The content may include an attachment (such as a document) and/or a body of the communication 206. The context of the content may include a classification associated with the content provided by an entity such as the recipient, a sender, and/or a third party provider, among others.

The inference engine 211 may query a relationship graph 214 provided by a cloud service 222 to retrieve a signal 216 and a signal value 217 associated with the attribute 205. The relationship graph may describe a relationship of a node such as the recipient 210 with other node(s) within the signal 216. Alternatively, the communication service 202 may manage the relationship graph 214. The signal 216 may describe a frequency, a duration, a date and time, a summary, and a result of an interaction between a node such as the recipient 210 and other node (also known as an entity). The entity may include a person, a group, an organization, and/or an object, among others.

The signal value 217 may be processed with a weight value 209 to generate a weighted signal value for the signal 216. The recipient 210 and/or a stakeholder associated with the communication 206 may be provided with operation(s) to customize the weight value 209 that is used to adjust the weighted signal value (as such the rank value 207) to match an interest of the recipient 210 and/or the stakeholder in the communication 206. A rank value 207 may be computed for the communication 206 from the weighted signal value. The rank value 207 may be normalized to a number within a value range (such as 0-10, 0-100, and/or 0-1, among others).

A presentation module 220 of the communication service 202 may provide the communication 206 with the rank value 207 to a client application 201 for ordering the communication 206 based on the rank value 207. The client application 203 may be instructed to present the ranked communication to the recipient 210 alone with the rank value 207. The tank value 207 may be provided to the recipient 210 to prompt the recipient 210 to affirm the rank value 207 (thus the correct order of the communication 206 according to the recipient) and/or customize the rank value 207 by adjusting the weight value 209.

Alternatively, the inference engine 211 may identify multiple attributes associated with the communication. The relationship graph 214 may be queried for the attributes to retrieve corresponding signals and associated signal values. The signal values may be processed with weight values to generate weighted signal values. The weighted signal values may be aggregated to compute the rank value 207 of the communication 206.

The inference engine 211 may also receive au input from a stakeholder (such as the recipient 210) to adjust the weight value 209 applied to the signal 216. A machine learning scheme may also adjust the weight value 209 by analyzing action(s) (by the recipient) executed in relation to the attribute to quantify an interest of the user in the communication 206. In response, the weight value 209 may be adjusted based on the input. The weighted signal value may also be adjusted by processing the signal value 217 with the adjusted weight value. Next, the rank value 207 may be updated for the communication 206 with the adjusted weighted signal value. The communication 206 may also be provided (to a client application) with the updated rank value for re-ordering the communication 206.

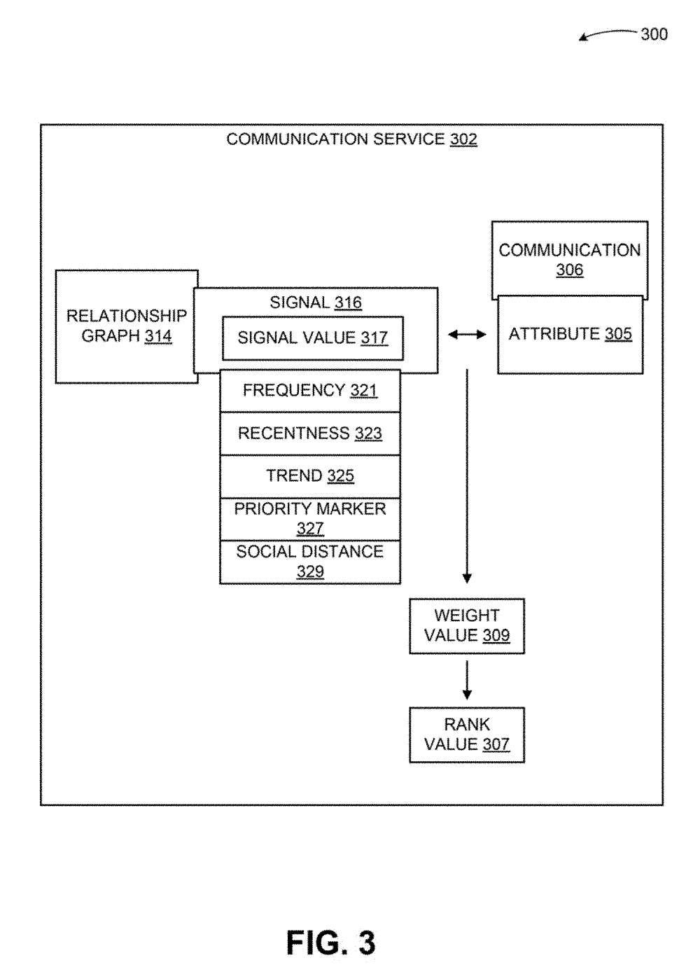

FIG. 3 is a display diagram illustrating components of a scheme to provide a communication ranking scheme based on a relationship graph, according to embodiments.

In a diagram 300, a communication service 302 may identify an attribute 305 of a communication 306 and query and retrieve a signal 316 and a signal value 317 associated with the attribute 305 from a relationship graph 314. The signal value 317 may be processed with a weight value 309 to produce a weighted signal value that is aggregated (along with other weighted signal value(s)) into a rank value 307 for the communication 306 to order the communication 306 based on an interest of a recipient.

The attribute 305 of the communication 306 may be associated with varieties of the signal 316 (and the associated signal value 317) that include a frequency 321 of an interaction between the recipient and a sender identified as the attribute 305. The signal 316 may also be associated with a recentness 323 of an interaction between the recipient and the sender. Furthermore, the signal 316 may be associated with a trend 325 of a context of a content of the communication. The context is identified as the attribute 305.

The communication service 302 may also retrieve the signal 316 and the signal value 317 associated with a priority marker 327 set on the communication 306. The communication service 302 may also retrieve the signal 316 and the signal value 317 that includes a social distance 329 between the recipient and the sender (identified as the attribute 305).

The signal value 317 may be adjusted based on the frequency 321 of an interaction between the recipient and the sender. An increase in the frequency 321 of the interaction may be correlated to an increase in the signal value 317 that correlates to an increased interest of the recipient in the communication 306. Alternatively, a decrease in the frequency 312 of the interaction between the recipient and the sender may be correlated to a decrease in the signal value 317 that correlates to a decreased interest of the recipient in the communication 306.

The signal value 317 may also be adjusted based on the recentness 323 of an interaction between the recipient and the sender. The signal value 317 may be adjusted based on a proximity of the recentness 323 of the interaction to a current time. The signal value 317 is increased in response to detecting the recentness 323 as near to a current time. Alternatively, the signal value 317 is decreased in response to detecting the recentness 323 as distant from the current time. The values associated with nearness or distance to the current time may be configured by a stakeholder of the communication 306 (such as the recipient).

The signal value 317 may further be adjusted based on a trend 325 of a context of the content of the email. The trend 325 may be retrieved from a social networking provider. The signal value 317 may be increased in response to detecting an increase in the trend of the context. The signal value 317 may be decreased in response to detecting a decrease in the trend 325 of the context.

In another example scenario, the signal value 317 may be increased upon detecting a priority marker 327 (as the attribute 305) set on the communication 306. Alternatively, the signal value 317 may be decreased upon a failure to detect the priority marker 327 set on the communication 306.

Alternatively, the signal value 317 may be adjusted based on a level and a reminder associated with the priority marker 327 detected from the signal 316. The signal value 317 is increased upon detecting a high level assigned to the priority marker and/or detecting the reminder as near a current time. The signal value 317 is decreased upon detecting a low level assigned to the priority marker and/or detecting the reminder as distant from a current time. The high level and the low level may be configured by a stakeholder associated with the communication 306. The distant or near position in relation to the current time may be configured by the stakeholder associated with the communication 306, as well.

The signal value 317 may also be adjusted based on a social distance 329 between the recipient and a sender of the communication 306. The signal value 317 is increased upon detecting a high number of nodes between the recipient and the sender. The signal value 317 is decreased upon detecting a low number of nodes between the recipient and the sender. The high number and the low number of nodes may be configured and/or customized by a stakeholder associated with the communication 306 (such as the recipient).

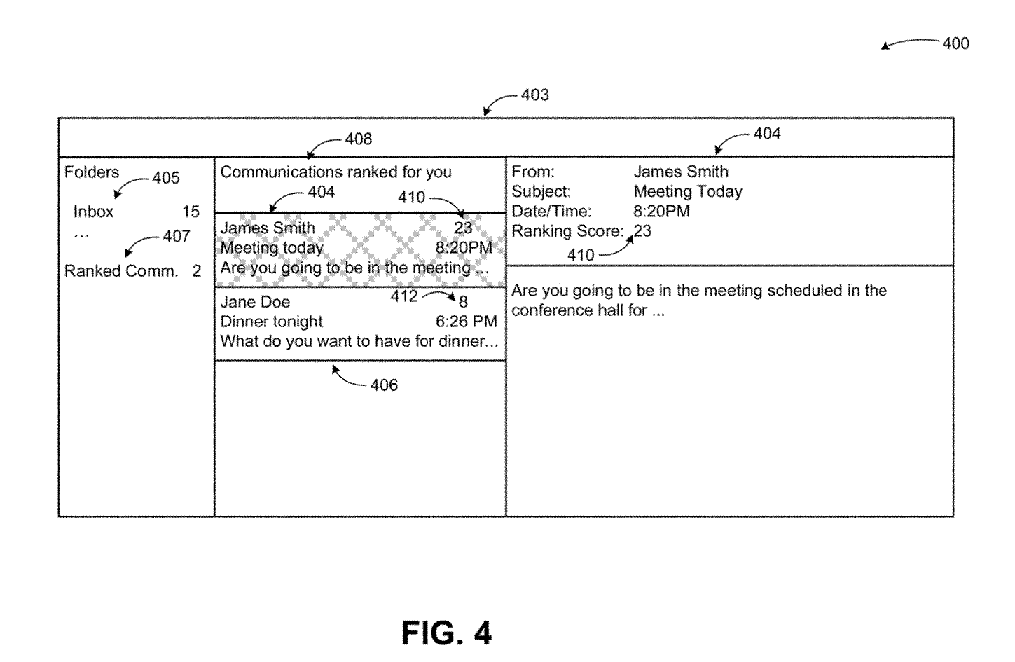

FIG. 4 is a display diagram illustrating an example of an interface that provides ranked communications and rank values based on a relationship graph, according to embodiments.

In a diagram 400, a communication service may provide an interface to be rendered by a client application 403 or provide data to be displayed by the interface of the client application 403 such as a communication application. The communication service may provide a communication 404 and a communication 406 that are ordered based on rank values (410 and 412, respectively). The rank values (410 and 412) are computed based on signal value(s) associated with attribute(s) of the communications (404 and 406) that provide information to quantify an interest of the recipient in the communications (404 and 406). The client application 403 may provide navigation elements (405 and 407) as controls to access a grouping of the communication(s). Upon activation, the navigation element 405 may display all communication(s) intended for the recipient. Upon activation, the navigation element 407 may display communications ranked based on a rank value associated with signal value(s).

The client application 403 may display the communications (404 and 406) in a section 408 reserved for ranked communications based on rank value(s). The communications (404 and 406) are ordered based on the rank values (410 and 412) which simulate an interest of the recipient in the communications (404 and 406). When selected, the communication 404 may be provided with details such as the rank value 410. The rank value 410 may be provided to affirm an accuracy of the assigned value that is intended to reflect an interest of the recipient in the communication 404. Furthermore, the rank value 410 is provided to prompt the recipient to adjust the weight value associated with the signal value to reflect the interest that the recipient may have in the communication 404.

As discussed above, the communication service may be employed to perform operations to automate providing a communication ranking scheme based on a relationship graph. An increased user efficiency with the client application may occur as a result of processing a communication through the communication service 102 to rank the communication with a rank value associated with a signal. Additionally, processing the communication, the signal, and a weight value, by the communication service 102, may reduce processor load, increase processing speed, conserve memory, and reduce network bandwidth usage.

Embodiments, as described herein, address a need to efficiently triage and prioritize a communication. The actions/operations described herein are not a mere use of a computer, but address results that are a direct consequence of software used as a service offered to large numbers of users and applications.

The example scenarios and schemas in FIGS. 1A through 4 are shown with specific components, data types, and configurations. Embodiments are not limited to systems according to these example configurations. Providing a communication ranking scheme based on a relationship graph may be implemented in configurations employing fewer or additional components in applications and user interfaces. Furthermore, the example schema and components shown in FIGS. 1A through 4 and their subcomponents may be implemented in a similar manner with other values using the principles described herein.

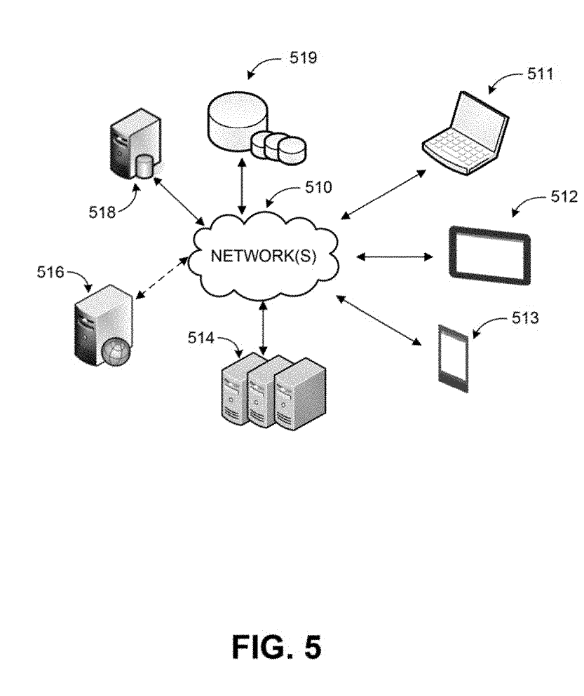

FIG. 5 is an example networked environment, where embodiments may be implemented. A communication service configured to provide a communication ranking scheme based on a relationship graph may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A communication service may identify an attribute of a communication upon receiving the communication intended for a recipient. A relationship graph may be queried to retrieve a signal and a signal value associated with the attribute. The signal value may be processed with a weight value to generate a weighted signal value that is used to compute a rank value for the communication. The communication is provided (to a client application) along with the rank value for ordering the communication based on the rank value. The communication service may store data associated with the communication in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a communication ranking scheme based on a relationship graph. Furthermore, the networked environments discussed in FIG. 5 are for illustration purposes only. Embodiments are not limited to the example applications, modules, or processes.

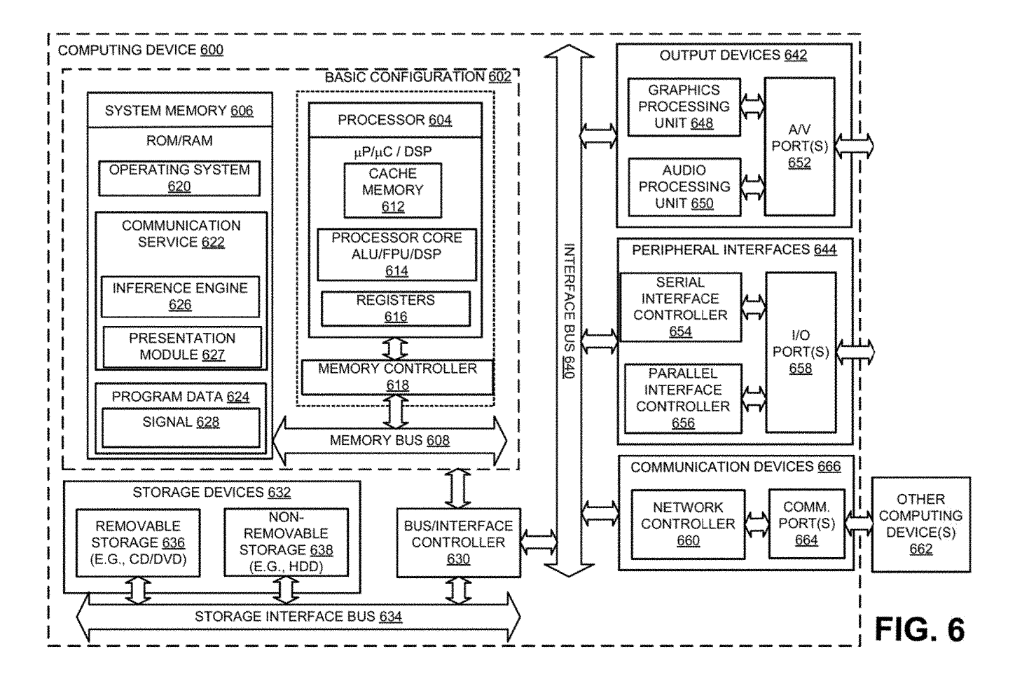

FIG. 6 is a block diagram of an example computing device, which may be used to provide a communication ranking scheme based on a relationship graph, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication service 622, and a program data 624. The communication service 622 may include components such as an inference engine 626 and a presentation module 627. The inference engine 626 and the presentation module 627 may execute the processes associated with the communication service 622. The inference engine 626 may identify an attribute of a communication upon receiving the communication intended for a recipient. A relationship graph may be queried to retrieve a signal and a signal value associated with the attribute. The signal value may be processed with a weight value to generate a weighted signal value that is used to compute a rank value for the communication. Next, the presentation module may provide the communication along with the rank value for ordering the communication based on the rank value.

Input to and output out of the communication service 622 may be transmitted through a communication device associated with the computing device 600. An example of the communication device may include a networking device that may be communicatively coupled to the computing device 600. The networking device may provide wired and/or wireless communication. The program data 624 may also include, among other data, signal 628, or the like, as described herein. The signal 628 may include a signal value associated with the communication that may be adjusted with a weight value to produce a rank value, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may, include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented, in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or r tore other computing devices 662 over a network communication link via one or more communication ports 664. The one or more other computing devices 662 may include servers, computing devices, and comparable devices.

The network communication link may be one example, of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide a communication ranking scheme based on a relationship graph. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

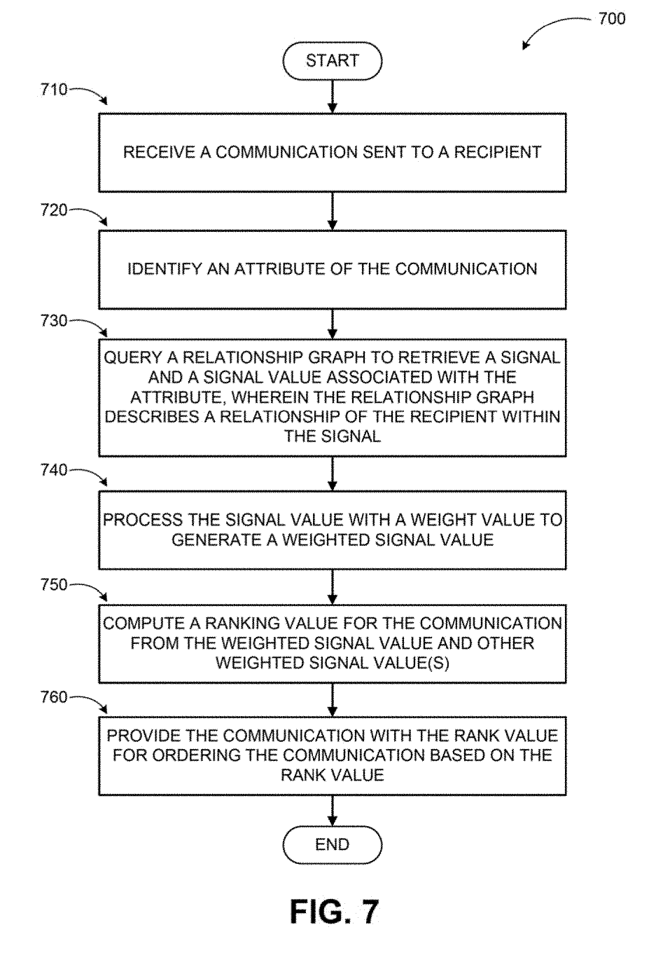

FIG. 7 is a logic flow diagram illustrating a process for providing a communication ranking scheme based on a relationship graph, according to embodiments. Process 700 may be implemented on a computing device, such as the computing device 600 or another system.

Process 700 begins with operation 710, where the communication service may receive a communication sent to a recipient. At operation 720, an attribute of the communication may be identified. The attribute may include an address of the recipient, an address of a sender, an address of a co-recipient, a date and time of a transmission, a subject, and/or a context of a content of the communication, among others. At operation 730, a relationship graph may be queried to retrieve a signal and a signal value associated with the attribute. The relationship graph may describe a relationship of the recipient within the signal.

At operation 740, the signal value may be processed with a weight value to generate a weighted signal value. At operation 750, a rank value is computed for the communication from the weighted signal value and other weighted signal value(s). At operation 760, the communication may be provided along with the rank value for ordering the communication based on the rank value.

The operations included in process 700 are for illustration purposes. Providing a communication ranking scheme based on a relationship graph may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a method executed on a computing device to provide a communication ranking scheme based on a relationship graph is described. The method includes receiving a communication sent to a recipient, identifying an attribute of the communication, querying the relationship graph to retrieve a signal and a signal value associated with the attribute, where the relationship graph describes a relationship of the recipient within the signal, processing the signal value with a weight value to generate a weighted signal value, computing a rank value for the communication by aggregating the weighted signal value and one or more other weighted signal values, and providing the communication with the rank value for ordering the communication based on the rank value.

In other examples, the attribute of the communication includes one or more of an address of the recipient, an address of a sender, an address of a co-recipient, a date and time of a transmission, a subject, and a context of a content of the communication. The method further includes identifying other attribute of the communication, querying the relationship graph to retrieve one or more other signals and one or more other signal values associated with the other attribute of the communication, and processing the one or more other signal values with one or more other weight values to generate the one or more other weighted signal values.

In further examples, the method further includes receiving an input from a stakeholder to adjust the weight value, adjusting the weight value based on the input, adjusting the weighted signal value by processing the signal value with the adjusted weight value, updating the rank value based on the adjusted weighted signal value, and providing the communication with the updated rank value for ordering the communication based on the updated rank value. The method further includes adjusting the weight value based on a machine learning scheme, where the machine learning scheme is configured to process one or more actions executed by the recipient associated with the attribute, adjusting the weighted signal value by processing the signal value with the adjusted weight value, updating the rank value based on the adjusted weighted signal value, and providing the communication with the updated rank value for ordering the communication based on the updated rank value.

In other examples, the signal describes one or more of a frequency, a duration, a date and time, a summary, and a result of an interaction between the recipient and an entity, where the entity includes one or more of a person and an object. The method further includes retrieving the signal associated with a sender of the communication identified as the attribute, where the signal includes a frequency of an interaction between the recipient and the sender, increasing the signal value in response to detecting a thigh value for the frequency of the interaction between the recipient and the sender, and decreasing the signal value in response to detecting a low value for the frequency of the interaction between the recipient and the sender.

In further examples, the method further includes detecting a sender of the communication as the attribute and locating the signal associated with the sender, where the signal describes a recentness of an interaction between the sender and the recipient. The method further includes adjusting the signal value based on a proximity of the recentness of the interaction to a current time, where the signal value is increased in response to detecting the recentness as near to the current time. The method further includes adjusting the signal value based on a proximity of the recentness of the interaction to a current time, where the signal value is decreased in response to detecting the recentness as distant from the current time.

In some examples, a communication server to provide a communication ranking scheme based on a relationship graph is described. The server includes a communication device, a memory configured to store instructions associated with a communication service, processor(s) coupled to the memory and the communication device. The processor(s) execute the communication service in conjunction with the instructions stored in the memory. The communication service includes an inference engine and a presentation module. The inference engine is configured to receive an email sent to a recipient, identity an attribute of the email, where the attribute includes one or more of an address of the recipient, an address of a sender, an address of a co-recipient, a date and time of a transmission, a subject, and a context of a content of the email, query the relationship graph to retrieve a signal and a signal value associated with the attribute, where the relationship graph describes a relationship of the recipient within the signal, process the signal value with a weight value to generate a weighted signal value, compute a rank value for the email by aggregating the weighted signal value and one or more other weighted signal values. The presentation module is configured to provide, through the communication device, the email with the rank value for ordering the email based on the rank value.

In other examples, the inference engine is further configured to locate the signal associated with the context of the content of the email within the relationship graph, where the context is identified as the attribute and the signal describes a trend of the context within a social networking provider. The inference engine is further configured to increase the signal value in response to detecting an increase in the trend of the context and decrease the signal value in response to detecting a decrease in the trend of the context. The inference engine is further configured to in response to detecting the attribute as a priority marker set on the email, increase the signal value and in response to a failure to detect the attribute as the priority marker set on the email, decrease the signal value.

In further examples, the inference engine is further configured to detect the attribute as a priority marker set on the email, retrieve the signal associated with the priority marker, where the signal describes a level and a reminder associated with the priority marker, and adjust the signal value based on the level and the reminder associated with the priority marker, where the signal value is increased in response to detecting one or more of: a high value assigned to the level, and the reminder as near a current time, and the signal value is decreased in response to detecting one or more of: a low value assigned to the level, and the reminder as distant to the current time. The inference engine is further configured to locate the signal associated with a social distance between the recipient and the sender, where the sender is identified as the attribute and the signal describes a social graph of the recipient; and adjust the signal value based on the social distance, where the signal value is increased in response to detecting a high number of nodes between the recipient and the sender, and the signal value is decreased in response to detecting a low number of nodes between the recipient and the sender.

In some examples, a system to provide a communication ranking scheme based on a relationship graph is described. The system includes cloud server(s) executing a cloud service. The cloud service is configured to maintain the relationship graph. The system also includes a communication server executing a communication service. The communication service is configured to execute actions that are similar to the actions of the computing device.

In other examples, the cloud service is further configured to normalize the rank value to a number within a value range. The cloud service is further configured to instruct the client application to display the rank value along with the email.

In some examples, a means for providing a communication ranking scheme based on a relationship graph. The means for providing a communication ranking scheme based on a relationship graph includes a means for receiving a communication sent to a recipient, a means for identifying art attribute of the communication, a means for querying the relationship graph to retrieve a signal and a signal value associated with the attribute, where the relationship graph describes a relationship of the recipient within the signal, a means for processing the signal value with a weight value to generate a weighted signal value, a means for computing a rank value for the communication by aggregating the weighted signal value and one or more other weighted signal values, and a means for providing the communication with the rank value for ordering the communication based on the rank value.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide a communication ranking scheme based on a relationship graph, the method comprising:
receiving a communication sent to a recipient;
identifying an attribute of the communication;
querying the relationship graph to retrieve a signal and a signal value associated with the attribute, wherein the relationship graph describes a relationship of the recipient within the signal;
processing the signal value with a weight value to generate a weighted signal value;
computing a rank value for the communication by aggregating the weighted signal value and one or more other weighted signal values; and
providing the communication with the rank value for ordering the communication based on the rank value.

2. The method of claim 11, wherein the attribute of the communication includes one or more of an address of the recipient, an address of a sender, an address of a co-recipient, a date and time of a transmission, a subject, and a context of a content of the communication.

3. The method of claim 1, further comprising:
identifying other attribute of the communication;
querying the relationship graph to retrieve one or more other signals and one or more other signal values associated with the other attribute of the communication; and
processing the one or more other signal values with one or more other weight values to generate the one or more other weighted signal values.

4. The method of claim 1, further comprising:
receiving an input from a stakeholder to adjust the weight value;
adjusting the weight value based on the input;
adjusting the weighted signal value by processing the signal value with the adjusted weight value;
updating the rank value based on the adjusted weighted signal value; and
providing the communication with the updated rank value for ordering the communication based on the updated rank value.

5. The method of claim 1, further comprising:
adjusting the weight value based on a machine learning scheme, wherein the machine learning scheme is configured to process one or more actions executed by the recipient associated with the attribute;
adjusting the weighted signal value by processing the signal value with the adjusted weight value;
updating the rank value based on the adjusted weighted signal value; and
providing the communication with the updated rank value for ordering the communication based on the updated rank value.

6. The method of claim 1, wherein the signal describes one or more of a frequency, a duration, a date and time, a summary, and a result of an interaction between the recipient and an entity, wherein the entity includes one or more of a person and an object.

7. The method of claim 1, further comprising:
retrieving the signal associated with a sender of the communication identified as the attribute, wherein the signal includes a frequency of an interaction between the recipient and the sender.

8. The method of claim 7, further comprising:
increasing the signal value in response to detecting a high value for the frequency of the interaction between the recipient and the sender; and
decreasing the signal value in response to detecting a low value for the frequency of the interaction between the recipient and the sender.

9. The method of claim 1, further comprising:
detecting a sender of the communication as the attribute; and
locating the signal associated with the sender, wherein the signal describes a recentness of an interaction between the sender and the recipient.

10. The method of claim 9, further comprising:
adjusting the signal value based on a proximity of the recentness of the interaction to a current time, wherein the signal value is increased in response to detecting the recentness as near to the current time.

11. The method of claim 9, further comprising:
adjusting the signal value based on a proximity of the recentness of the interaction to a current time, wherein the signal value is decreased in response to detecting the recentness as distant from the current time.

12. A communication server to provide a communication ranking scheme based on a relationship graph, the server comprising:
a communication device;
a memory configured to store instructions associated with a communication service;
one or more processors coupled to the memory and the communication device, the one or more processors executing the communication service in conjunction with the instructions stored in the memory, wherein the communication service includes:
an inference engine configured to:
receive an email sent to a recipient;
identify an attribute of the email, wherein the attribute includes one or more of an address of the recipient, an address of a sender, an address of a co-recipient, a date and time of a transmission, a subject, and a context of a content of the email;
query the relationship graph to retrieve a signal and a signal value associated with the attribute, wherein the relationship graph describes a relationship of the recipient within the signal;
process the signal value with a weight value to generate a weighted signal value;
compute a rank value for the email by aggregating the weighted signal value and one or more other weighted signal values; and
a presentation module configured to:
provide, through the communication device, the email with the rank value for ordering the email based on the rank value.

13. The communication server of claim 12, wherein the inference engine is further configured to:
locate the signal associated with the context of the content of the email within the relationship graph, wherein the context is identified as the attribute and the signal describes a trend of the context within a social networking provider.

14. The communication server of claim 13, wherein the inference engine is further configured to:
increase the signal value in response to detecting an increase in the trend of the context; and
decrease the signal value in response to detecting a decrease in the trend of the context.

15. The communication server of claim 12, wherein the inference engine is further configured to:
in response to detecting the attribute as a priority marker set on the email, increase the signal value; and
in response to a failure to detect the attribute as the priority marker set on the email, decrease the signal value.

16. The communication server of claim 12, wherein the inference engine is further configured to:
detect the attribute as a priority marker set on the email;
retrieve the signal associated with the priority marker, wherein the signal describes a level and a reminder associated with the priority marker; and
adjust the signal value based on the level and the reminder associated with the priority marker, wherein
the signal value is increased in response to detecting one or more of:
a high value assigned to the level, and
the reminder as near a current time, and
the signal value is decreased in response to detecting one or more of:
a low value assigned to the level, and
the reminder as distant to the current time.

17. The communication server of claim 12, wherein the inference engine is further configured to:
locate the signal associated with a social distance between the recipient and the sender, wherein the sender is identified as the attribute and the signal describes a social graph of the recipient; and
adjust the signal value based on the social distance, wherein
the signal value is increased in response to detecting a high number of nodes between the recipient and the sender, and
the signal value is decreased in response to detecting a low number of nodes between the recipient and the sender.

18. A system to provide a communication ranking scheme based on a relationship graph, the system comprising:
one or more cloud servers executing a cloud service, the cloud service configured to:
maintain the relationship graph;
a communication server executing a communication service, the communication service configured to:
receive an email sent to a recipient;
identify an attribute of the email, wherein the attribute includes one or more of an address of the recipient, an address of a sender, an address of a co-recipient, a date and time of a transmission, a subject, and a context of a content of the email;
query the relationship graph, provided from the cloud service, to retrieve a signal and a signal value associated with the attribute, wherein the relationship graph describes a relationship of the recipient within the signal;
process the signal value with a weight value to generate a weighted signal value;
compute a rank value for the email by aggregating the weighted signal value and one or more other weighted signal values; and
provide the email with the rank value to a client application for ordering the email based on the rank value.

19. The system of claim 18, wherein the communication service is further configured to:
normalize the rank value to a number within a value range.

20. The system of claim 18, wherein the communication service is further configured to:
instruct the client application to display the rank value along with the email.
